(19) United States
(12) Patent Application Publication
(10) Pub. No.: US 2019/0056622 A1
(43) Pub. Date: Feb. 21, 2019

(54) TRANSFLECTIVE LIQUID CRYSTAL DISPLAY AND MANUFACTURING METHOD THEREOF

(71) Applicant: Shenzhen China Star Optoelectronics Semiconductor Display Technology Co., Ltd., Shenzhen City (CN)

(72) Inventors: Minggang Liu, Shenzhen City (CN); Yunglun Lin, Shenzhen City (CN)

(21) Appl. No.: 15/578,715

(22) PCT Filed: Nov. 15, 2017
(86) PCT No.: PCT/CN2017/111021

§ 371 Date: Dec. 1, 2017

(30) Foreign Application Priority Data
Aug. 16, 2017 (CN) 201710703207.9

(51) Int. Cl. G02F 1/1335; G02F 1/1368; G02F 1/1339; G02F 1/1343; G02F 1/13363

(52) U.S. Cl. CPC G02F 1/133555; G02F 1/1368; G02F 1/133512; G02F 2001/136222; G02F 1/13439; G02F 1/133528; G02F 1/13363; G02F 1/13394

(57) ABSTRACT

The present invention provides a transflective liquid crystal display and a manufacturing method thereof. The transflective liquid crystal display adopts an arrangement involving COA and BPS and includes a plurality of first bumps formed on a black matrix of a BPS light-shielding layer and provides a reflective electrode on the black matrix of the BPS light-shielding layer to cover the plurality of first bumps to make an upper surface thereof forming a plurality of convex faces, the reflective electrode being connected to a pixel electrode so as to form a reflective zone in an area of a device that corresponds to the reflective electrode and also to form a transmissive zone in an area corresponding to the pixel electrode thereby increasing brightness of a displayed image when the external light is intense. Further, liquid crystal cell thicknesses in the reflective zone and the transmissive zone are controllable through controlling the thickness of the black matrix without the necessity of adding an extra insulation layer so that the structure is made simple. In addition, the reflective zone does not occupy an area of the transmissive zone and thus does not affect the transmission rate of the device. Homogeneity of exit light of the reflective zone is greatly enhanced and the displaying quality is made high.

### BACKGROUND OF THE INVENTION

### 1. Field of the Invention

The present invention relates to the field of liquid crystal display technology, and more particular to a transflective liquid crystal display and a manufacturing method thereof.

### 2. The Related Arts

With the progress of the display technology, flat panel display devices, such as liquid crystal displays (LCDs), due to various advantages, such as high image quality, low power consumption, thin device body, and wide range of applications, have been widely used in all sorts of consumer electronic products, including mobile phones, televisions, personal digital assistants (PDAs), digital cameras, notebook computers, and desktop computers so as to take a leading position in the field of flat panel display devices.

According to lighting requirement, the LCDs that are currently available in the market can be roughly divided into three categories, including transmissive liquid crystal displays, reflective liquid crystal displays, and transflective liquid crystal displays. The transmissive liquid crystal displays includes a backlight module arranged on the back side of a liquid crystal panel to serve as a light source, wherein light emitting from the backlight module transmits through a transparent pixel electrode of an array substrate to display an image. The transmissive liquid crystal displays are fit to environments of weak light sources, such as being used indoors. However, for outdoor use, since the external lighting is excessively strong, the magnitude of the backlighting is affected by the external light so that eyes, when viewing the display, cannot perceives clear images due to excessive brightness of the panel and this affects the image quality. In addition, long term uses of the backlight source would consume a large amount of electrical power. Display devices of small sizes are generally powered by electrical batteries and a situation of running out of power may readily occur.

The reflective liquid crystal displays use front lighting or external natural lighting as a light source and involve an array substrate that is provided with a reflective electrode that is made of a metal or other materials that show excellent reflectivity so that the front lighting or external natural lighting can be reflected by the reflective electrode to realize image displaying. The reflective liquid crystal displays are suitable for use in sites where the external light source is strong so that image displaying can be realized through reflection of natural light and power consumption of the displays can be reduced. However, in sites where light source is weak, a situation of insufficient light intensity may occur, and this affects the image quality.

The transflective liquid crystal display panels are a combination of the transmissive and reflective liquid crystal display panels, and comprise an array substrate in which a reflective zone and a transmissive zone are both provided so that displaying can be achieved by using both the backlighting and front lighting or external lighting. In an environment where the lighting is dark, the liquid crystal display panel displays an image by primarily using the transmissive mode, meaning using lighting from the backlight source of the liquid crystal display itself, and in a situation where light, such as sunlight, is sufficient, the reflective mode is used, where the reflective electrode provided in the liquid crystal display panel reflects the external natural light to serve as a light source for image displaying. Thus, the transflective liquid crystal displays are applicable to external environments of various lighting intensity and particularly showing the characteristics of outdoor visibility and requiring no high brightness level of the backlighting thereby featuring low power consumption.

Referring to FIG. 1, which is a schematic view showing a structure of a conventional transflective liquid crystal display device, the transflective liquid crystal display device comprises an upper substrate 100′ and a lower substrate 200′ that are arranged opposite to each other and a liquid crystal layer 300′ arranged between the upper substrate 100′ and the lower substrate 200′, wherein the upper substrate 100′ is a color filter substrate that includes a common electrode 110′, and the lower substrate 200′ comprises an array substrate 210′, an insulation layer 220′ arranged on the array substrate 210′, and a reflective electrode 230′ arranged on the insulation layer 220′. The lower substrate 200′ comprises a reflective zone 201′ and a transmissive zone 202′. The insulation layer 220′ and the reflective electrode 230′ both correspond to the reflective zone 201′. The array substrate 210′ is provided, in the transmissive zone 202′, with a pixel electrode 211′. A portion of the liquid crystal layer 300′ that corresponds to the reflective zone 201′ has a thickness that is one half of that of a portion that corresponds to the transmissive zone 202′. The transflective liquid crystal display device, although capable of transmissive-reflective displaying, suffers the existence of the reflective zone 201′ that severely affects the transmission rate of the liquid crystal display device, and requires control of the thickness of the insulation layer 220′ such that the thickness of the liquid crystal layer 300′ in the reflective zone 201′ is one half of the thickness thereof in the transmissive zone 202′, the manufacturing process being complicated and hard to achieve, and exit light from the reflective zone 201′ being of poor homogeneity.

### SUMMARY OF THE INVENTION

Objectives of the present invention are to provide a transflective liquid crystal display, which increases brightness of a displayed image when the intensity of external lighting is high, and shows a high transmission rate, requires no additional insulation layer, and has a simple structure and homogeneity of exit light from a reflective zone.

Objectives of the present invention are also to provide a manufacturing method of a transflective liquid crystal display such that a transflective liquid crystal display so manufactured increases brightness of a displayed image when the intensity of external lighting is high, and shows a high transmission rate and homogeneity of exit light from a reflective zone, and has a simple operation.

To achieve the above objectives, the present invention provides a transflective liquid crystal display, which comprises: an upper substrate and a lower substrate that are arranged opposite to each other and a liquid crystal layer arranged between the upper substrate and the lower substrate;

wherein the lower substrate comprises a first backing, a thin-film transistor (TFT) array layer arranged on the first backing, a color resist layer arranged on the TFT array layer, a planarization layer covering the color resist layer, a black-photo-spacer (BPS) light-shielding layer arranged on the planarization layer, a pixel electrode arranged on the planarization layer, and a reflective electrode arranged on the BPS light-shielding layer;

the BPS light-shielding layer comprises a black matrix and a main photo spacer and a sub photo spacer arranged on the black matrix and spaced from each other, wherein the black matrix is provided, in a portion thereof other than portions in which the main photo spacer and the sub photo spacer are arranged, with a plurality of first bumps; the reflective electrode is arranged on the black matrix and covers the plurality of first bumps so as to form a plurality of convex faces on an upper surface thereof; and the reflective electrode is connected to the pixel electrode; and

the liquid crystal layer has a portion corresponding to the reflective electrode and having a thickness that is one half of a thickness of a portion thereof corresponding to the pixel electrode.

The planarization layer is provided with a plurality of second bumps such that the black matrix is formed with the plurality of first bumps that respectively correspond to the plurality of second bumps.

The transflective liquid crystal display further comprises an upper polarizer plate arranged on one side of the upper substrate that is distant from the lower substrate, a lower polarizer plate arranged on one side of the lower substrate that is distant from the upper substrate, and two quarter-wave plates respectively arranged between the upper substrate and the upper polarizer plate and between the low substrate and the lower polarizer plate;

wherein the upper polarizer plate has an optical axis that is parallel to an axis of the lower polarizer plate; and

wherein the transflective liquid crystal display further comprises a backlight module arranged on one side of the lower polarizer plate that is distant from the lower substrate.

The upper substrate comprises a second backing and a common electrode arranged on one side of the second backing that is adjacent to the lower substrate.

The reflective electrode is formed of a material comprising aluminum or silver.

The present invention also provides a manufacturing method of a transflective liquid crystal display, which comprises the following steps:

Step S1: providing a first backing and forming, in sequence, a thin-film transistor (TFT) array layer and a color resist layer on the first backing;

Step S2: forming a planarization layer on the color resist layer;

Step S3: coating a black-photo-spacer (BPS) material layer on the planarization layer and using a first mask to subject the BPS material layer to a photolithographic operation to form a BPS light-shielding layer,

wherein the BPS light-shielding layer comprises a black matrix and a main photo spacer and a sub photo spacer arranged on the black matrix and spaced from each other and the black matrix is provided, in a portion thereof other than portions in which the main photo spacer and the sub photo spacer are arranged, with a plurality of first bumps;

Step S4: forming a pixel electrode on the planarization layer and forming a reflective electrode on the black matrix to cover the plurality of first bumps, wherein the reflective layer forms a plurality of convex faces on an upper surface thereof to respectively correspond to the first bumps and the reflective electrode is connected to the pixel electrode to form a lower substrate; and

Step S5: providing an upper substrate, laminating the lower substrate and the upper substrate together, and positioning a liquid crystal layer between the upper substrate and the lower substrate,

wherein the liquid crystal layer has a portion corresponding to the reflective electrode and having a thickness that is one half of a thickness of a portion thereof corresponding to the pixel electrode.

The first mask comprises a multi-tone mask or a gray scale mask.

Step S2 comprises:

Step S21: coating an organic material layer on the color resist layer;

Step S22: using a second mask to subject the organic material layer to exposure and development so as to form a plurality of organic material patterns on the organic material layer, wherein each of the organic material patterns comprises a first organic block and a second organic block that are stacked together and the first organic block has a size greater than a size of the second organic block; and

Step S23: baking and shaping the plurality of organic patterns to form the planarization layer with a plurality of second bumps provided thereon,

wherein after the BPS light-shielding layer is formed on the planarization layer in Step S3, the black matrix is formed with the plurality of first bumps thereon to respectively correspond to the plurality of second bumps.

Step S3 comprises:

Step S31: coating the BPS material layer on the planarization layer,

Step S32: using the first mask to subject to the BPS material layer to exposure and development to form the black matrix and the main photo spacer and the sub photo spacer that are located on the black matrix and also to form a plurality of black resist patterns in a portion of the black matrix other than the portions in which the main photo spacer and the sub photo spacer are arranged, wherein each of the black resist patterns comprises a first black resist block and a second black resist block that stacked together and the first black resist block has a size greater than a size of the second black resist block; and

Step S33: baking and shaping the plurality of black resist patterns to form the plurality of first bumps on the black matrix.

The manufacturing method of the transflective liquid crystal display further comprises:

Step S6: arranging an upper polarizer plate on one side of the upper substrate that is distant from the lower substrate, arranging a lower polarizer plate on one side of the lower substrate that is distant from the upper substrate, arranging quarter-wave plates at locations respectively between the upper substrate and the upper polarizer plate and between the low substrate and the lower polarizer plate, and arranging a backlight module at one side of the lower polarizer plate that is distant from the lower substrate so as to form the liquid crystal display;

wherein the upper substrate comprises a second backing and a common electrode arranged on the second backing, wherein Step S5 is conducted such that one side of the lower substrate that is provided with the pixel electrode is laminated onto one side of the upper substrate that is provided with the common electrode.

The present invention further provides a transflective liquid crystal display, which comprises: an upper substrate and a lower substrate that are arranged opposite to each other and a liquid crystal layer arranged between the upper substrate and the lower substrate;

wherein the lower substrate comprises a first backing, a thin-film transistor (TFT) array layer arranged on the first backing, a color resist layer arranged on the TFT array layer, a planarization layer covering the color resist layer, a black-photo-spacer (BPS) light-shielding layer arranged on the planarization layer, a pixel electrode arranged on the planarization layer, and a reflective electrode arranged on the BPS light-shielding layer;

the BPS light-shielding layer comprises a black matrix and a main photo spacer and a sub photo spacer arranged on the black matrix and spaced from each other, wherein the black matrix is provided, in a portion thereof other than portions in which the main photo spacer and the sub photo spacer are arranged, with a plurality of first bumps; the reflective electrode is arranged on the black matrix and covers the plurality of first bumps so as to form a plurality of convex faces on an upper surface thereof; and the reflective electrode is connected to the pixel electrode; and

the liquid crystal layer has a portion corresponding to the reflective electrode and having a thickness that is one half of a thickness of a portion thereof corresponding to the pixel electrode;

wherein the planarization layer is provided with a plurality of second bumps such that the black matrix is formed with the plurality of first bumps that respectively correspond to the plurality of second bumps;

further comprising an upper polarizer plate arranged on one side of the upper substrate that is distant from the lower substrate, a lower polarizer plate arranged on one side of the lower substrate that is distant from the upper substrate, and two quarter-wave plates respectively arranged between the upper substrate and the upper polarizer plate and between the low substrate and the lower polarizer plate;

wherein the upper polarizer plate has an optical axis that is parallel to an axis of the lower polarizer plate; and

wherein the transflective liquid crystal display further comprises a backlight module arranged on one side of the lower polarizer plate that is distant from the lower substrate;

wherein the upper substrate comprises a second backing and a common electrode arranged on one side of the second backing that is adjacent to the lower substrate; and

wherein the reflective electrode is formed of a material comprising aluminum or silver.

The efficacy of the present invention is that the present invention provides a transflective liquid crystal display, which adopts an arrangement involving COA and BPS and comprises a plurality of first bumps formed on a black matrix of a BPS light-shielding layer and provides a reflective electrode on the black matrix of the BPS light-shielding layer to cover the plurality of first bumps to make an upper surface thereof forming a plurality of convex faces, the reflective electrode being connected to a pixel electrode so as to form a reflective zone in an area of a device that corresponds to the reflective electrode and also to form a transmissive zone in an area corresponding to the pixel electrode thereby increasing brightness of a displayed image when the external light is intense. Further, liquid crystal cell thicknesses in the reflective zone and the transmissive zone are controllable through controlling the thickness of the black matrix without the necessity of adding an extra insulation layer so that the structure is made simple. In addition, the reflective zone does not occupy an area of the transmissive zone and thus does not affect the transmission rate of the device. Homogeneity of exit light of the reflective zone is greatly enhanced and the displaying quality is made high. The present invention provides a manufacturing method of a transflective liquid crystal display, such that a transflective liquid crystal display manufactured therewith may increase brightness of a displayed image when the external light is intense, has a high light transmission rate, provides homogeneous exit light of the reflective zone, and is easy to operate.

### BRIEF DESCRIPTION OF THE DRAWINGS

For better understanding of the features and technical contents of the present invention, reference will be made to the following detailed description of the present invention and the attached drawings. However, the drawings are provided only for reference and illustration and are not intended to limit the present invention.

In the drawings:

FIG. 1 is a schematic view illustrating a cross-sectional structure of a conventional transflective liquid crystal display;

FIG. 2 is a schematic view illustrating a cross-sectional structure of a first embodiment of a transflective liquid crystal display according to the present invention;

FIG. 3 is a schematic view illustrating a cross-sectional structure of a second embodiment of the transflective liquid crystal display according to the present invention;

FIG. 4 is a top plan view illustrating a color resist layer and a black-photo-spacer (BPS) light-shielding layer of the transflective liquid crystal display according to the present invention;

FIG. 5 is a flow chart illustrating a manufacturing method of a transflective liquid crystal display according to the present invention;

FIG. 6 is a schematic view illustrating Step S1 of the manufacturing method of a transflective liquid crystal display according to the present invention;

FIG. 7 is a schematic view illustrating Step S2 of the manufacturing method of a transflective liquid crystal display according to a first embodiment of the present invention;

FIG. 8 is a schematic view illustrating Step S3 of the manufacturing method of a transflective liquid crystal display according to the first embodiment of the present invention;

FIGS. 9-11 are schematic views illustrating formation of first bumps in Step S3 of the manufacturing method of a transflective liquid crystal display according to the first embodiment of the present invention;

FIG. 12 is a schematic view illustrating Step S4 of the manufacturing method of a transflective liquid crystal display according to the first embodiment of the present invention;

FIG. 13 is a schematic view illustrating Step S5 of the manufacturing method of a transflective liquid crystal display according to the first embodiment of the present invention;

FIG. 14 is a schematic view illustrating Step S2 of the manufacturing method of a transflective liquid crystal display according to a second embodiment of the present invention;

FIGS. 15-17 are schematic views illustrating formation of second bumps in Step S2 of the manufacturing method of a transflective liquid crystal display according to the second embodiment of the present invention;

FIG. 18 is a schematic view illustrating Step S3 of the manufacturing method of a transflective liquid crystal display according to the second embodiment of the present invention;

FIG. 19 is a schematic view illustrating Step S4 of the manufacturing method of a transflective liquid crystal display according to the second embodiment of the present invention; and

FIG. 20 is a schematic view illustrating Step S5 of the manufacturing method of a transflective liquid crystal display according to the second embodiment of the present invention.

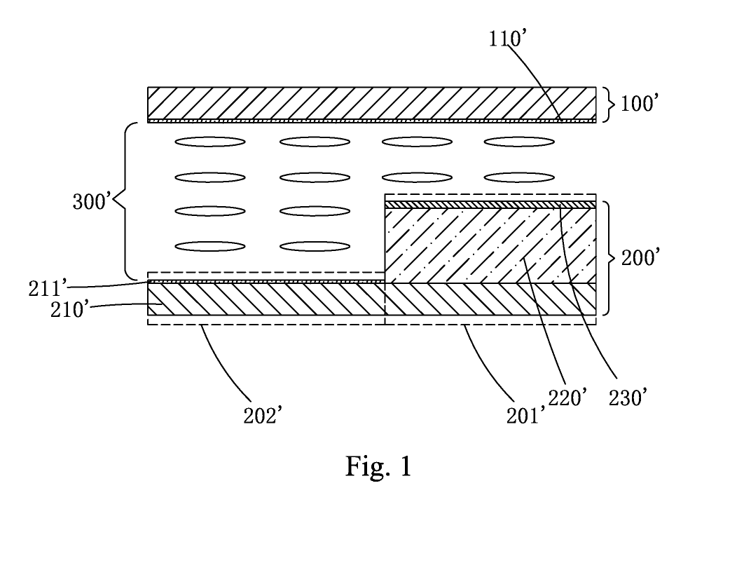

### DETAILED DESCRIPTION OF THE PREFERRED EMBODIMENTS

To further expound the technical solution adopted in the present invention and the advantages thereof, a detailed description will be given with reference to the preferred embodiments of the present invention and the drawings thereof.

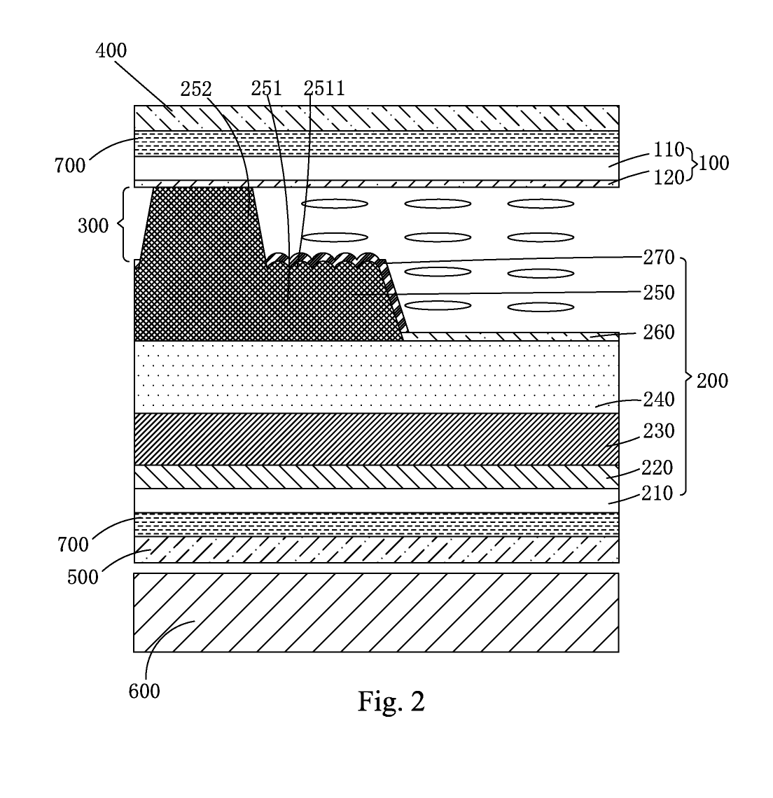

The present invention provides a transflective liquid crystal display, which involves the application of a technique that allows a color filter layer to be directly formed on an array substrate (namely Color Filter on Array, COA) and a technique that allows a black matrix and main and sub photo spacers to be formed of a black-photo-spacer (BPS) material with the same manufacturing process. Referring to FIG. 2, which illustrates a first embodiment of the transflective liquid crystal display according to the present invention, the transflective liquid crystal display according to the present invention comprises: an upper substrate 100 and a lower substrate 200 that are arranged opposite to each other, a liquid crystal layer 300 arranged between the upper substrate 100 and the lower substrate 200, an upper polarizer plate 400 arranged on one side of the upper substrate 100 that is distant from the lower substrate 200, a lower polarizer plate 500 arranged on one side of the lower substrate 200 that is distant from the upper substrate 100, a backlight module 600 arranged on one side of the lower polarizer plate 500 that is distant from the lower substrate 200, and two quarter-wave plates 700 respectively arranged between the upper substrate 100 and the upper polarizer plate 400 and between the low substrate 200 and the lower polarizer plate 500.

The lower substrate 200 comprises a first backing 210, a thin-film transistor (TFT) array layer 220 arranged on the first backing 210, a color resist layer 230 arranged on the TFT array layer 220, a planarization layer 240 covering the color resist layer 230, a BPS light-shielding layer 250 arranged on the planarization layer 240, a pixel electrode 260 arranged on the planarization layer 240, and a reflective electrode 270 arranged on the BPS light-shielding layer 250.

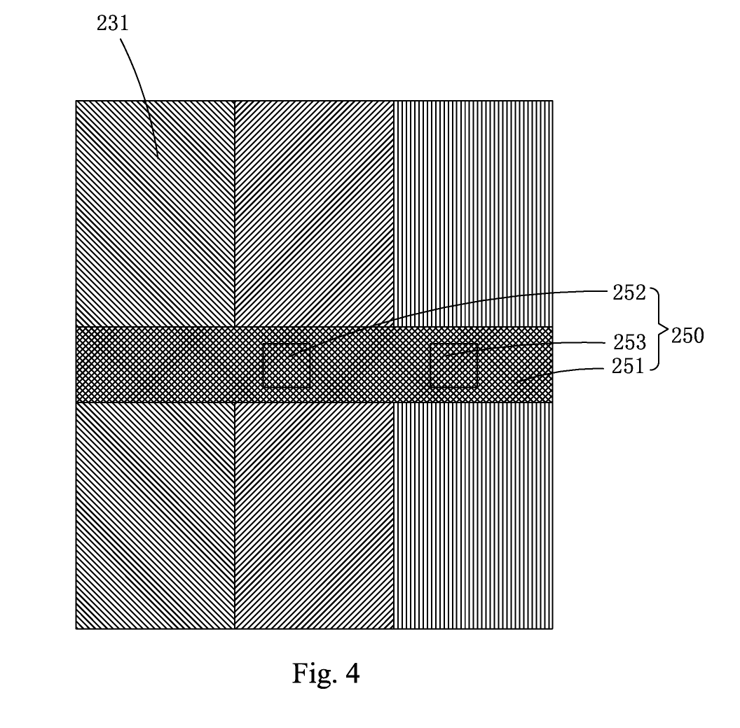

It is noted that, reference being had to FIG. 2 in combination with FIG. 4, the BPS light-shielding layer 250 comprises a black matrix 251 and a main photo spacer 252 and a sub photo spacer 253 arranged on the black matrix 251 and spaced from each other. The black matrix 251 is provided, in a portion thereof other than portions in which the main photo spacer 252 and the sub photo spacer 253 are arranged, with a plurality of first bumps 2511. The reflective electrode 270 is arranged on the black matrix 251 and covers the plurality of first bumps 2411 so as to form a plurality of convex faces on an upper surface thereof. The reflective electrode 270 is connected to the pixel electrode 260.

The liquid crystal layer 300 has a portion corresponding to the reflective electrode 270 and having a thickness that is one half of a thickness of a portion thereof corresponding to the pixel electrode 260.

Specifically, the upper polarizer plate 400 has an optical axis that is parallel to an axis of the lower polarizer plate 500. In other words, without application of an electrical voltage, the transflective liquid crystal display of the present invention is in a normally black state.

Specifically, the upper substrate 100 comprises a second backing 110 and a common electrode 120 arranged on one side of the second backing 110 that is adjacent to the lower substrate 200.

It is noted that the transflective liquid crystal display of the present invention adopts a BPS arrangement, in which the black matrix 251 of the BPS light-shielding layer 250 are provided with a plurality of first bumps 2511 and the reflective electrode 270 is arranged on the black matrix 251 and covers the plurality of first bumps 2411 and the reflective electrode 270 is connected to the pixel electrode 260 so as to form a reflective zone in an area corresponding to the reflective electrode 270 and also form a transmissive zone in an area corresponding to the pixel electrode 260 with a distance between the pixel electrode 260 and the upper substrate 100 being twice of a distance between the reflective electrode 270 and the upper substrate 100 to make optical path difference equal for both the transmissive zone and the reflective zone. Under a condition of no application of electrical voltage, the transmissive zone is in a dark state. Since the optical path difference of the reflective zone is the same as that of the transmissive zone, the reflective zone is also in a dark state. When an electrical voltage is applied between the common electrode 120 and the pixel electrode 260 to make the transmissive zone a bright state, since the pixel electrode 260 and the reflective electrode 270 are connected, portions of liquid crystal in the transmissive zone and the reflective zone are of synchronous rotation so that the reflective zone is also in a bright state thereby increasing displaying brightness of an image. Further, the more intense the external light is, the higher the brightness of the reflective zone will be and the higher the displaying brightness of an image. Further, with an arrangement of the first bumps 2511 on the black matrix 251, after the reflective electrode 270 is formed on the black matrix 251, the upper surface of the reflective electrode 270 is caused to form a plurality of convex faces respectively corresponding to the plurality of first bumps 2511 so that when light gets incident onto the transflective liquid crystal display from one side of the upper substrate 100, light that gets incident to the upper surface of the reflective electrode 270 is scattered by the plurality of the convex faces of the reflective electrode 270 to project out of the transflective liquid crystal display to thereby greatly improve homogeneity of exit light from the reflective zone and significantly enhance displaying quality. Also, by controlling operation parameters for the formation of the BPS light-shielding layer 250, it can readily control a height difference between the black matrix 251 and the planarization layer 240 and a height difference between the black matrix 251 and the main photo spacer 252 so that a distance between the pixel electrode 260 that is formed on the planarization layer 240 and the upper substrate 100 is double of a distance between the reflective electrode 270 that is formed on the black matrix 251 and the upper substrate 100, and this, as compared to the known techniques, requires no additional insulation layer to be included, has a simple structure, and involves a manufacturing process that has a low level of difficulty, and in addition, the reflective zone is arranged on the black matrix 251 without occupying an area of the transmissive zone so as not to affect the transmission rate of a device.

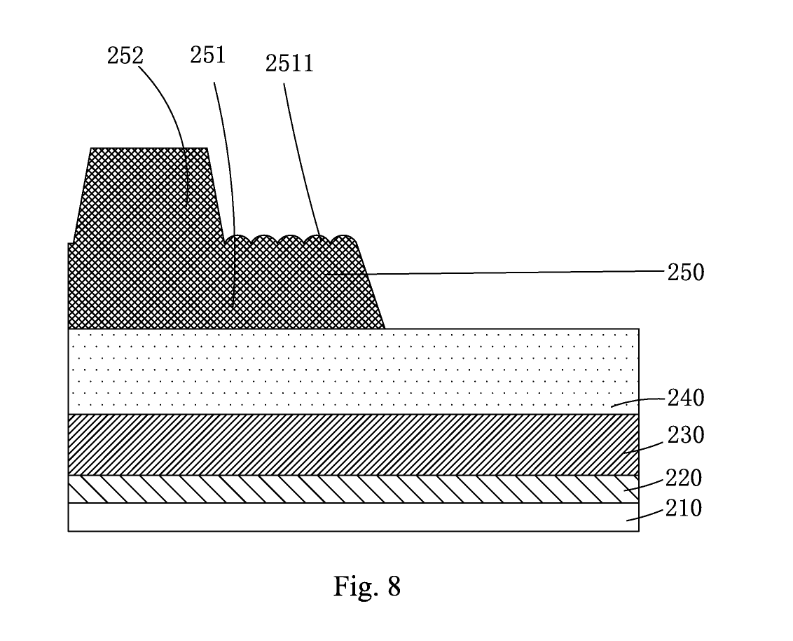

Specifically, with reference to FIG. 2, in a first embodiment of the present invention, the planarization layer 240 has an upper surface that is flat. With reference to FIGS. 8-11, a process for manufacturing first bumps 2511 on the black matrix 251 comprises: using a first mask to subject a BPS material layer 250′ to exposure and development to form the black matrix 251 and the main photo spacer 252 and the sub photo spacer 253 that are located on the black matrix 251 and also to form a plurality of a plurality of black resist patterns 251′ in a portion of the black matrix 251 other than the portions in which the main photo spacer 252 and the sub photo spacer 253 are arranged, wherein each of the black resist patterns 251′ comprises a first black resist block 2511′ and a second black resist block 2512′ that stacked together and the first black resist block 2511′ has a size greater than a size of the second black resist block 2512′, and then baking and shaping the plurality of black resist patterns 251′ to form the plurality of first bumps 2511 on the black matrix 251.

Specifically, the first mask is a multi-tone mask or a gray scale mask. Specifically, the first mask comprises a first light transmitting zone and a second light transmitting zone that are spaced from each other, a third light transmitting zone located outside the first light transmitting zone and the second light transmitting zone, and a light shielding zone located outside the third light transmitting zone. The first light transmitting zone has a light transmission rate greater than a light transmission rate of the second light transmitting zone, and the light transmission rate of the second light transmitting zone is greater than a light transmission rate of the third light transmitting zone. By using the first mask to subject the BPS material layer 250′ to exposure and development, the main photo spacer 252 is formed as corresponding to the first light transmitting zone; the sub photo spacer 253 is formed as corresponding to the second light transmitting zone; and the black matrix 251 is formed as corresponding to the first, second, and third light transmitting zones. Specifically, in the first embodiment of the present invention, the third light transmitting zone a first sub light transmitting zone, a second sub light transmitting zone located outside the first sub light transmitting zone, and a third sub light transmitting zone located outside the second light transmitting zone, wherein the first sub light transmitting zone has a light transmission rate greater than a light transmission rate of the second sub light transmitting zone, and the light transmission rate of the second sub light transmitting zone is greater than a light transmission rate of the third sub light transmitting zone, so that using the first mask to subject the BPS material layer 250′ to exposure and development, the second black resist block 2512′ is formed as corresponding to the first sub light transmitting zone and the first black resist block 2511′ is formed as corresponding to the first and second sub light transmitting zones.

Specifically, referring to FIG. 4, the color resist layer 230 comprises a plurality of color resist blocks 231 arranged in an array. The black matrix 251 shields an interface site between two adjacent lines of color resist unit 231.

Specifically, the reflective electrode 270 is formed of a material comprising aluminum, silver, or other conductive materials having high reflectivity.

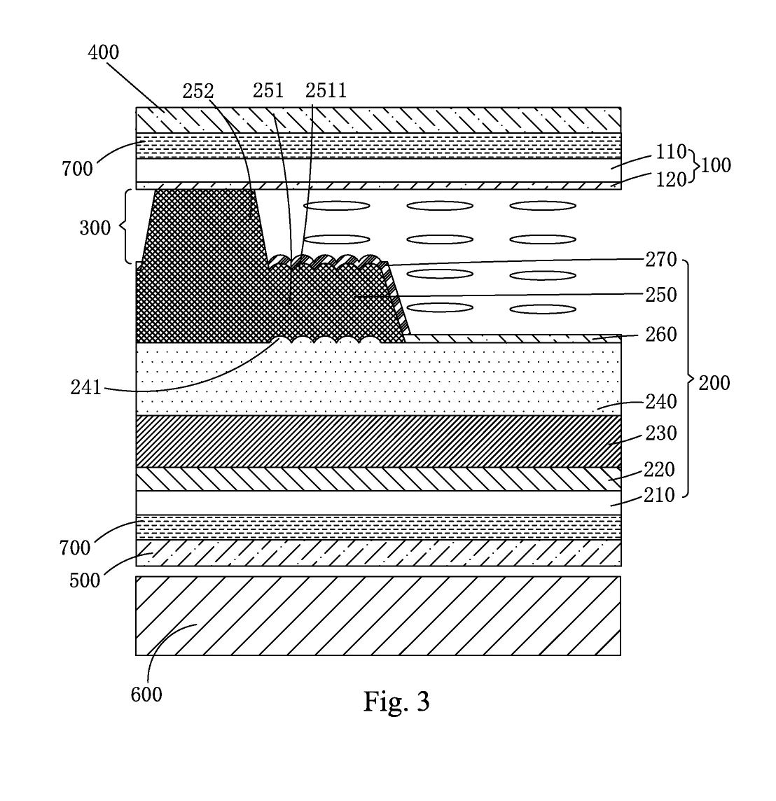

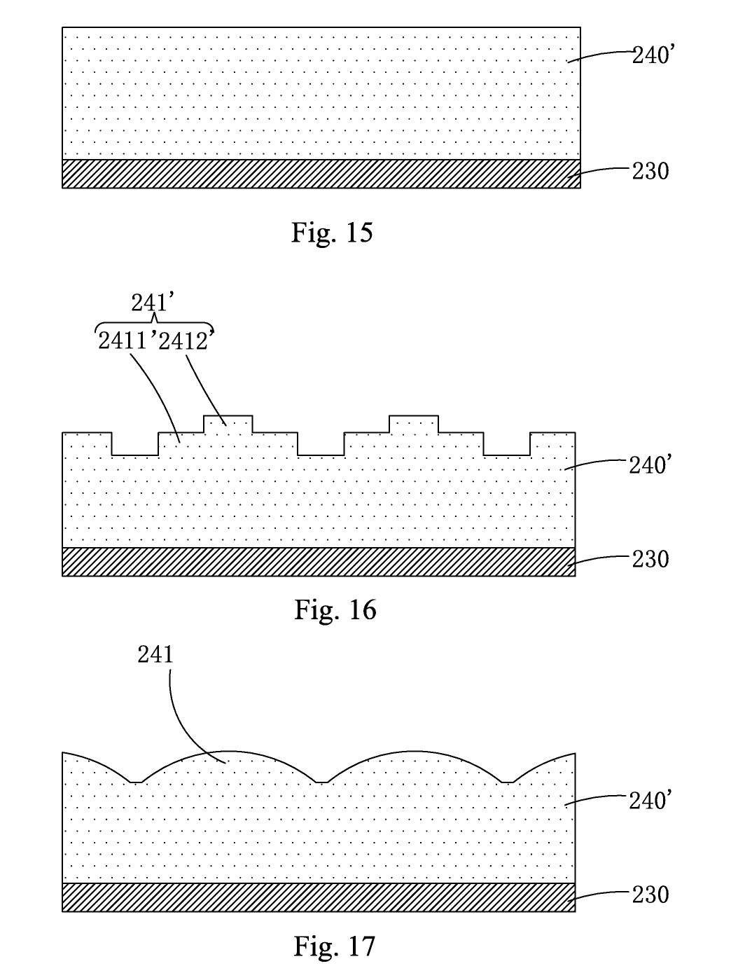

Referring to FIG. 3, which is a schematic view illustrating a cross-sectional structure of a first embodiment of a transflective liquid crystal display according to the present invention. The second embodiment is different from the above-described first embodiment in that the planarization layer 240 is provided with a plurality of second bumps 241 so that after the BPS light-shielding layer 250 is formed on the planarization layer 240, the black matrix 251 may form a plurality of first bumps 2511 respectively corresponding to the plurality of second bumps 241 whereby there is no need to form the black resist patterns 251′ on the black matrix 250 at the same time when the main and sub photo spacers 252, 253 are formed. With reference to FIGS. 15-17, a process for manufacturing the second bumps 241 on the planarization layer 240 comprises: using a second mask to subject an organic material layer 240′ formed on the color resist layer 230 to exposure and development so as to form a plurality of organic material patterns 241′ on the organic material layer 240′, wherein each of the organic material patterns 241′ comprises a first organic block 2411′ and a second organic block 2412′ that are stacked together and the first organic block 2411′ has a size greater than a size of the second organic block 2412′, and then baking and shaping the plurality of organic patterns 241′ to form the planarization layer 240 with the plurality of second bumps 2411 thereon.

Specifically, the second mask is a multi-tone mask. Specifically, the second mask comprises a fourth light transmitting zone, a fifth light transmitting zone located outside the fourth light transmitting zone, and a sixth light transmitting zone located outside the fifth light transmitting zone. For the organic material layer 240′ being formed of a material that comprises a positive photoresist material, the fourth light transmitting zone has a light transmission rate smaller than a light transmission rate of the fifth light transmitting zone and the light transmission rate of the fifth light transmitting zone is smaller than a light transmission rate of the sixth light transmitting zone so that using the second mask to subject the organic material layer 240′ to exposure and development, the second organic block 2412′ is formed as corresponding to the fourth light transmitting zone and the first organic block 2411′ is formed as corresponding to the fourth and fifth light transmitting zones; and for the organic material layer 240′ being formed of a material that comprises a negative photoresist material, the fourth light transmitting zone has a light transmission rate greater than a light transmission rate of the fifth light transmitting zone and the light transmission rate of the fifth light transmitting zone is greater than a light transmission rate of the sixth light transmitting zone so that using the second mask to subject the organic material layer 240′ to exposure and development, the second organic block 2412′ is formed as corresponding to the fourth light transmitting zone and the first organic block 2411′ is formed as corresponding to the fourth and fifth light transmitting zones. Compared with the first embodiment, the third zone of the first mask used in the second embodiment to form the BPS light-shielding layer 250 may have the same light transmission rate so as to make the cost low and manufacturing process simple.

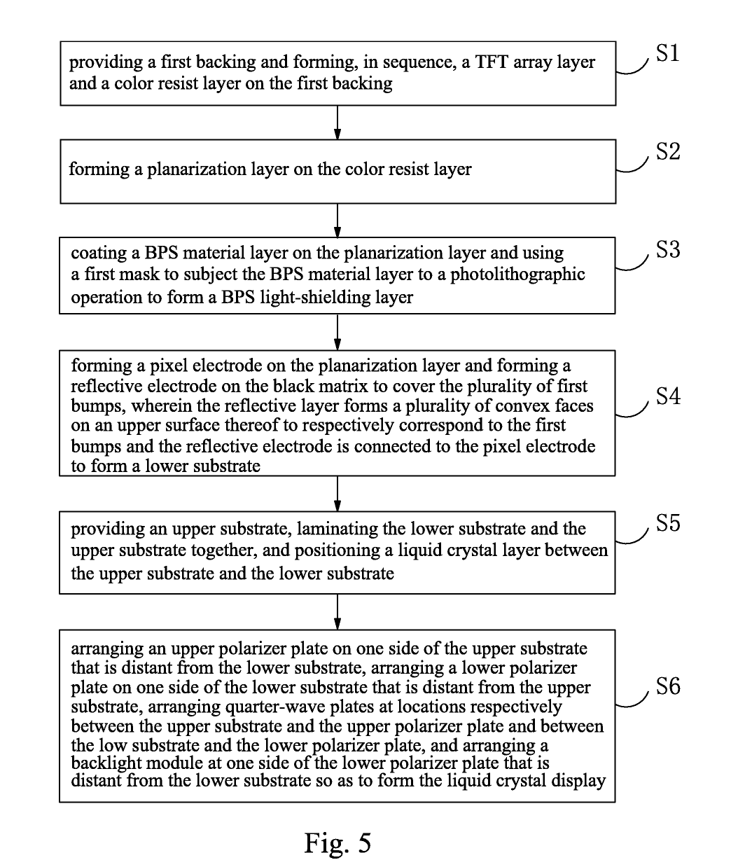

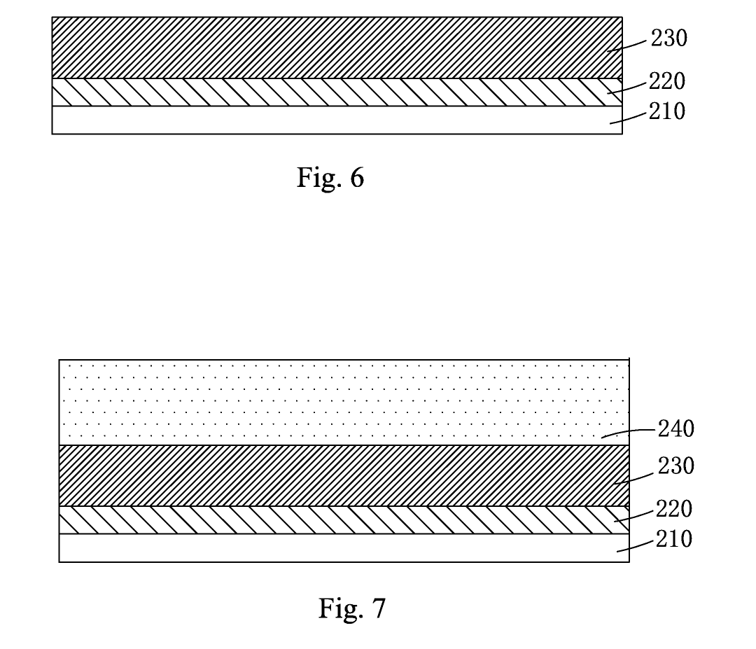

Referring to FIG. 5, based on the same inventive idea, the present invention also provides a manufacturing method of a transflective liquid crystal display. With reference to FIGS. 6-13, the manufacturing method of a transflective liquid crystal display according to the present invention comprises, in a first embodiment, the following steps:

Step S1: referring to FIG. 6, providing a first backing 210 and forming, in sequence, a TFT array layer 220 and a color resist layer 230 on the first backing 210.

Specifically, referring to FIG. 4, the color resist layer 230 comprises a plurality of color resist blocks 231 arranged in an array.

Step S2: referring to FIG. 7, forming a planarization layer 240 on the color resist layer 230.

Specifically, in the first embodiment of the present invention, the planarization layer 240 has an upper surface that is flat.

Step S3: referring to FIG. 8, coating a BPS material layer 250′ on the planarization layer 240 and using a first mask to subject the BPS material layer 250′ to a photolithographic operation to form a BPS light-shielding layer 250,

wherein the BPS light-shielding layer 250 comprises a black matrix 251 and a main photo spacer 252 and a sub photo spacer 253 arranged on the black matrix 251 and spaced from each other and the black matrix 251 is provided, in a portion thereof other than portions in which the main photo spacer 252 and the sub photo spacer 253 are arranged, with a plurality of first bumps 2511.

Specifically, the black matrix 251 shields an interface site between two adjacent lines of color resist unit 231.

Specifically, in the first embodiment of the present invention, Step S3 specifically comprises:

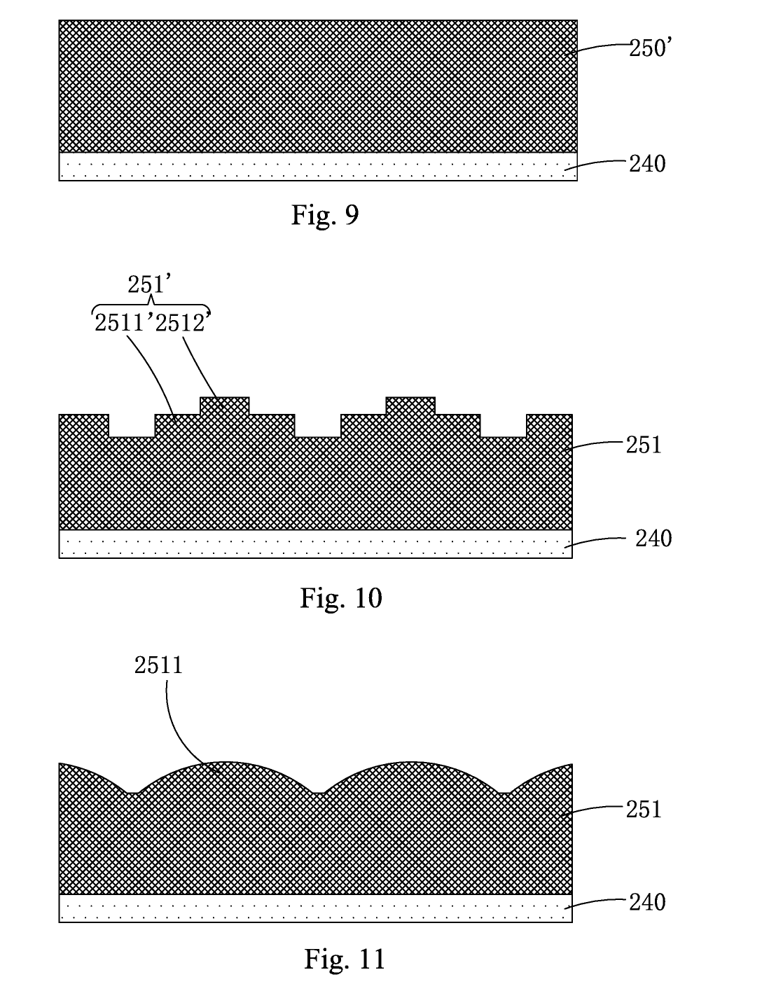

Step S31: referring to FIG. 9, coating the BPS material layer 250′ on the planarization layer 240.

Step S32: using the first mask to subject to the BPS material layer 250′ to exposure and development to form the black matrix 241 and the main photo spacer 252 and the sub photo spacer 253 that are located on the black matrix 251 and also to form, with reference to FIG. 10, a plurality of black resist patterns 251′ in a portion of the black matrix 251 other than the portions in which the main photo spacer 252 and the sub photo spacer 253 are arranged, wherein each of the black resist patterns 251′ comprises a first black resist block 2511′ and a second black resist block 2512′ that stacked together and the first black resist block 2511′ has a size greater than a size of the second black resist block 2512′.

Specifically, the first mask is a multi-tone mask or a gray scale mask. Specifically, the first mask comprises a first light transmitting zone and a second light transmitting zone that are spaced from each other, a third light transmitting zone located outside the first light transmitting zone and the second light transmitting zone, and a light shielding zone located outside the third light transmitting zone. The first light transmitting zone has a light transmission rate greater than a light transmission rate of the second light transmitting zone, and the light transmission rate of the second light transmitting zone is greater than a light transmission rate of the third light transmitting zone. By using the first mask to subject the BPS material layer 250′ to exposure and development, the main photo spacer 252 is formed as corresponding to the first light transmitting zone; the sub photo spacer 253 is formed as corresponding to the second light transmitting zone; and the black matrix 251 is formed as corresponding to the first, second, and third light transmitting zones. Specifically, in the first embodiment of the present invention, the third light transmitting zone a first sub light transmitting zone, a second sub light transmitting zone located outside the first sub light transmitting zone, and a third sub light transmitting zone located outside the second light transmitting zone, wherein the first sub light transmitting zone has a light transmission rate greater than a light transmission rate of the second sub light transmitting zone, and the light transmission rate of the second sub light transmitting zone is greater than a light transmission rate of the third sub light transmitting zone, so that using the first mask to subject the BPS material layer 250′ to exposure and development, the second black resist block 2512′ is formed as corresponding to the first sub light transmitting zone and the first black resist block 2511′ is formed as corresponding to the first and second sub light transmitting zones.

Step S33: referring to FIG. 11, baking and shaping the plurality of black resist patterns 251′ to form the plurality of first bumps 2511 on the black matrix 251.

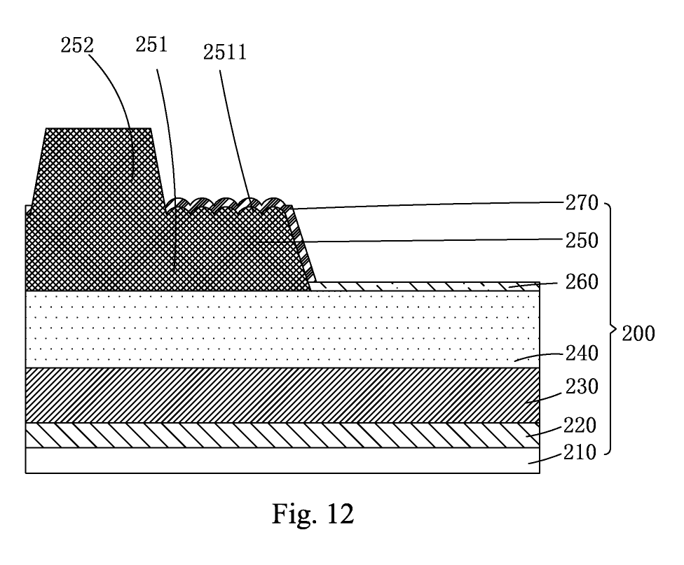

Step S4: referring to FIG. 12, forming a pixel electrode 260 on the planarization layer 240 and forming a reflective electrode 270 on the black matrix 251 to cover the plurality of first bumps 2511, wherein the reflective layer 270 forms a plurality of convex faces on an upper surface thereof to respectively correspond to the first bumps 2511 and the reflective electrode 270 is connected to the pixel electrode 260 to thereby form a lower substrate 200.

Specifically, the reflective electrode 270 is formed of a material comprising aluminum, silver, or other conductive materials having high reflectivity.

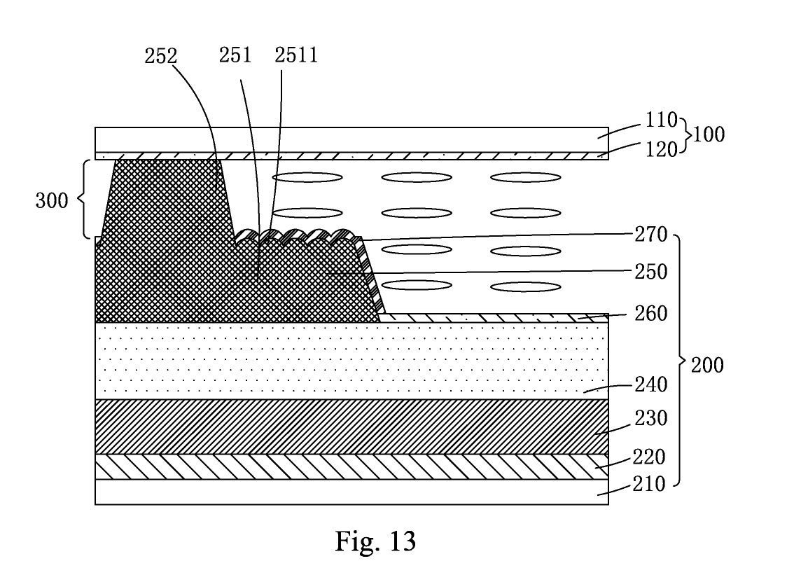

Step S5: referring to FIG. 13, providing an upper substrate 100, laminating the lower substrate 200 and the upper substrate 100 together, and positioning a liquid crystal layer 300 between the upper substrate 100 and the lower substrate 200,

wherein the liquid crystal layer 300 has a portion corresponding to the reflective electrode 270 and having a thickness that is one half of a thickness of a portion thereof corresponding to the pixel electrode 260.

Specifically, the upper substrate 100 comprises a second backing 110 and a common electrode 120 arranged on the second backing 110, wherein Step S5 is conducted such that one side of the lower substrate 200 that is provided with the pixel electrode 260 is laminated onto one side of the upper substrate 100 that is provided with the common electrode 120.

Step S6: arranging an upper polarizer plate 400 on one side of the upper substrate 100 that is distant from the lower substrate 200, arranging a lower polarizer plate 500 on one side of the lower substrate 200 that is distant from the upper substrate 100, arranging quarter-wave plates 700 at locations respectively between the upper substrate 100 and the upper polarizer plate 400 and between the low substrate 200 and the lower polarizer plate 500, and arranging a backlight module 600 at one side of the lower polarizer plate 500 that is distant from the lower substrate 200 so as to form a liquid crystal display as shown in FIG. 2.

It is noted that the present invention is structured such that the black matrix 251 of the BPS light-shielding layer 250 are provided with a plurality of first bumps 2511 and the reflective electrode 270 is arranged on the black matrix 251 and covers the plurality of first bumps 2411 and the reflective electrode 270 is connected to the pixel electrode 260 so as to form a reflective zone in an area corresponding to the reflective electrode 270 and also form a transmissive zone in an area corresponding to the pixel electrode 260 with a distance between the pixel electrode 260 and the upper substrate 100 being twice of a distance between the reflective electrode 270 and the upper substrate 100 to make optical path difference equal for both the transmissive zone and the reflective zone. Under a condition of no application of electrical voltage, the transmissive zone is in a dark state. Since the optical path difference of the reflective zone is the same as that of the transmissive zone, the reflective zone is also in a dark state. When an electrical voltage is applied between the common electrode 120 and the pixel electrode 260 to make the transmissive zone a bright state, since the pixel electrode 260 and the reflective electrode 270 are connected, portions of liquid crystal in the transmissive zone and the reflective zone are of synchronous rotation so that the reflective zone is also in a bright state thereby increasing displaying brightness of an image. Further, the more intense the external light is, the higher the brightness of the reflective zone will be and the higher the displaying brightness of an image. Further, with an arrangement of the first bumps 2511 on the black matrix 251, after the reflective electrode 270 is formed on the black matrix 251, the upper surface of the reflective electrode 270 is caused to form a plurality of convex faces respectively corresponding to the plurality of first bumps 2511 so that when light gets incident onto the transflective liquid crystal display from one side of the upper substrate 100, light that gets incident to the upper surface of the reflective electrode 270 is scattered by the plurality of the convex faces of the reflective electrode 270 to project out of the transflective liquid crystal display to thereby greatly improve homogeneity of exit light from the reflective zone and significantly enhance displaying quality. Also, by controlling operation parameters for the formation of the BPS light-shielding layer 250, it can readily control a height difference between the black matrix 251 and the planarization layer 240 and a height difference between the black matrix 251 and the main photo spacer 252 so that a distance between the pixel electrode 260 that is formed on the planarization layer 240 and the upper substrate 100 is double of a distance between the reflective electrode 270 that is formed on the black matrix 251 and the upper substrate 100, and this, as compared to the known techniques, requires no additional insulation layer to be included, has a simple structure, and involves a manufacturing process that has a low level of difficulty, and in addition, the reflective zone is arranged on the black matrix 251 without occupying an area of the transmissive zone so as not to affect the transmission rate of a device.

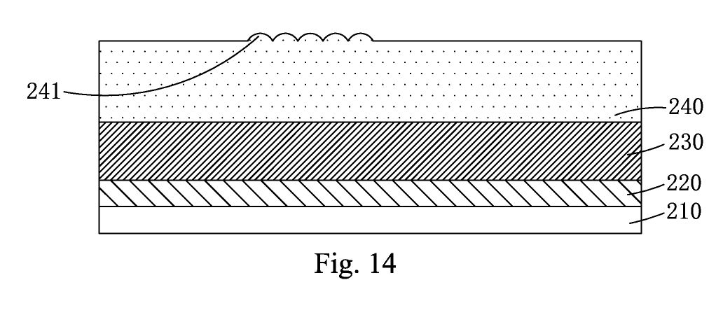

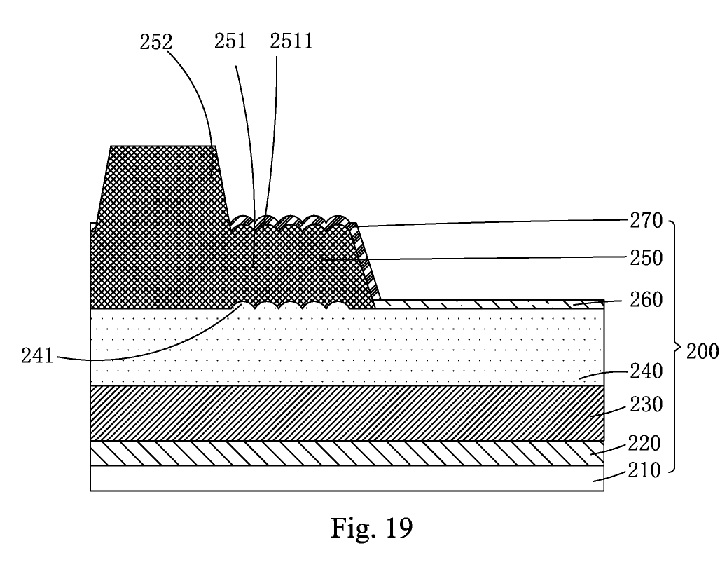

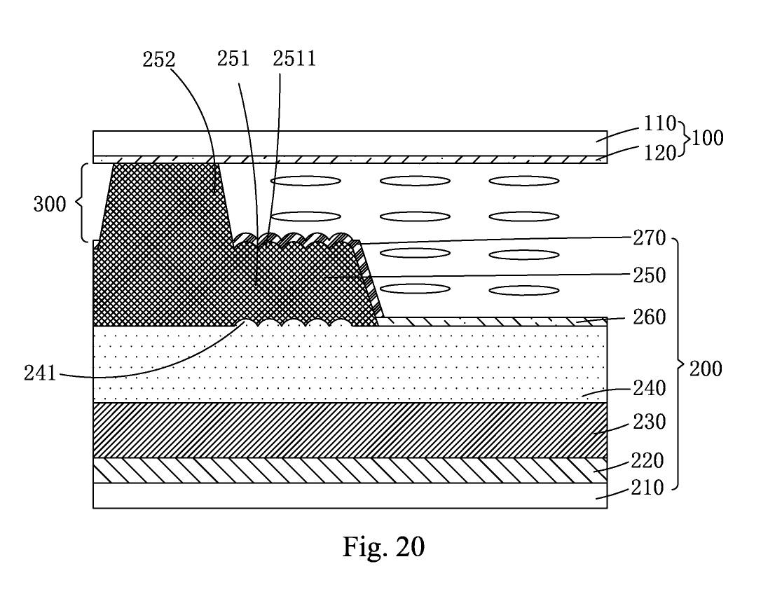

Referring to FIGS. 6 and 14-20, a second embodiment of the present invention as a manufacturing method of a transflective liquid crystal display is illustrated. The second embodiment is different from the first embodiment described above in that

Step S2 specifically comprises:

Step S21: referring to FIG. 15, coating an organic material layer 240′ on the color resist layer 230.

Step S22: using a second mask to subject the organic material layer 240′ to exposure and development so as to form a plurality of organic material patterns 241′ on the organic material layer 240′, wherein each of the organic material patterns 241′ comprises a first organic block 2411′ and a second organic block 2412′ that are stacked together and the first organic block 2411′ has a size greater than a size of the second organic block 2412′.

Step S23: baking and shaping the plurality of organic patterns 241′ to form the planarization layer 240 with a plurality of second bumps 2411 provided thereon.

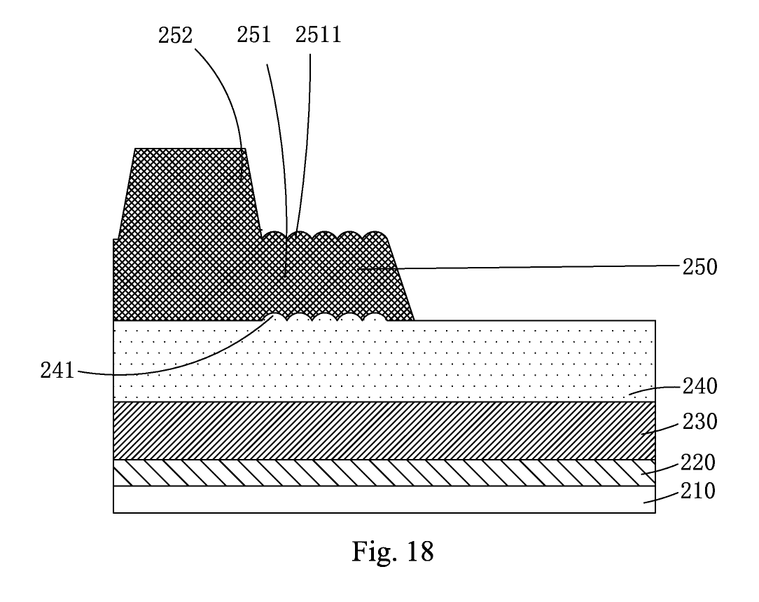

The first mask involved in Step S3 has the same light transmission rate for the third light transmitting zones so that, with reference to FIG. 18, after the BPS light-shielding layer 250 is formed on the planarization layer 240 in Step S3, the black matrix 251 may form a plurality of first bumps 2511 respectively corresponding to the plurality of second bumps 241. Compared with the first embodiment, the third light transmitting zone of the first mask used in the second embodiment to form the BPS light-shielding layer 250 may have the same light transmission rate so as to make the cost low and manufacturing process simple.

Specifically, the second mask is a multi-tone mask. Specifically, the second mask comprises a fourth light transmitting zone, a fifth light transmitting zone located outside the fourth light transmitting zone, and a sixth light transmitting zone located outside the fifth light transmitting zone. For the organic material layer 240′ being formed of a material that comprises a positive photoresist material, the fourth light transmitting zone has a light transmission rate smaller than a light transmission rate of the fifth light transmitting zone and the light transmission rate of the fifth light transmitting zone is smaller than a light transmission rate of the sixth light transmitting zone so that using the second mask to subject the organic material layer 240′ to exposure and development, the second organic block 2412′ is formed as corresponding to the fourth light transmitting zone and the first organic block 2411′ is formed as corresponding to the fourth and fifth light transmitting zones; and for the organic material layer 240′ being formed of a material that comprises a negative photoresist material, the fourth light transmitting zone has a light transmission rate greater than a light transmission rate of the fifth light transmitting zone and the light transmission rate of the fifth light transmitting zone is greater than a light transmission rate of the sixth light transmitting zone so that using the second mask to subject the organic material layer 240′ to exposure and development, the second organic block 2412′ is formed as corresponding to the fourth light transmitting zone and the first organic block 2411′ is formed as corresponding to the fourth and fifth light transmitting zones.

In summary, the present invention provides a transflective liquid crystal display, which adopts an arrangement involving COA and BPS and comprises a plurality of first bumps formed on a black matrix of a BPS light-shielding layer and provides a reflective electrode on the black matrix of the BPS light-shielding layer to cover the plurality of first bumps to make an upper surface thereof forming a plurality of convex faces, the reflective electrode being connected to a pixel electrode so as to form a reflective zone in an area of a device that corresponds to the reflective electrode and also to form a transmissive zone in an area corresponding to the pixel electrode thereby increasing brightness of a displayed image when the external light is intense. Further, liquid crystal cell thicknesses in the reflective zone and the transmissive zone are controllable through controlling the thickness of the black matrix without the necessity of adding an extra insulation layer so that the structure is made simple. In addition, the reflective zone does not occupy an area of the transmissive zone and thus does not affect the transmission rate of the device. Homogeneity of exit light of the reflective zone is greatly enhanced and the displaying quality is made high. The present invention provides a manufacturing method of a transflective liquid crystal display, such that a transflective liquid crystal display manufactured therewith may increase brightness of a displayed image when the external light is intense, has a high light transmission rate, provides homogeneous exit light of the reflective zone, and is easy to operate.

Based on the description given above, those having ordinary skills in the art may easily contemplate various changes and modifications of he technical solution and the technical ideas of the present invention. All these changes and modifications are considered belonging to the protection scope of the present invention as defined in the appended claims.

What is claimed is:

1. A transflective liquid crystal display, comprising: an upper substrate and a lower substrate that are arranged opposite to each other and a liquid crystal layer arranged between the upper substrate and the lower substrate;
wherein the lower substrate comprises a first backing, a thin-film transistor (TFT) array layer arranged on the first backing, a color resist layer arranged on the TFT array layer, a planarization layer covering the color resist layer, a black-photo-spacer (BPS) light-shielding layer arranged on the planarization layer, a pixel electrode arranged on the planarization layer, and a reflective electrode arranged on the BPS light-shielding layer;
the BPS light-shielding layer comprises a black matrix and a main photo spacer and a sub photo spacer arranged on the black matrix and spaced from each other, wherein the black matrix is provided, in a portion thereof other than portions in which the main photo spacer and the sub photo spacer are arranged, with a plurality of first bumps; the reflective electrode is arranged on the black matrix and covers the plurality of first bumps so as to form a plurality of convex faces on an upper surface thereof; and the reflective electrode is connected to the pixel electrode; and
the liquid crystal layer has a portion corresponding to the reflective electrode and having a thickness that is one half of a thickness of a portion thereof corresponding to the pixel electrode.

2. The transflective liquid crystal display as claimed in claim 1, wherein the planarization layer is provided with a plurality of second bumps such that the black matrix is formed with the plurality of first bumps that respectively correspond to the plurality of second bumps.

3. The transflective liquid crystal display as claimed in claim 1 further comprising an upper polarizer plate arranged on one side of the upper substrate that is distant from the lower substrate, a lower polarizer plate arranged on one side of the lower substrate that is distant from the upper substrate, and two quarter-wave plates respectively arranged between the upper substrate and the upper polarizer plate and between the low substrate and the lower polarizer plate;
wherein the upper polarizer plate has an optical axis that is parallel to an axis of the lower polarizer plate; and
wherein the transflective liquid crystal display further comprises a backlight module arranged on one side of the lower polarizer plate that is distant from the lower substrate.

4. The transflective liquid crystal display as claimed in claim 1, wherein the upper substrate comprises a second backing and a common electrode arranged on one side of the second backing that is adjacent to the lower substrate.

5. The transflective liquid crystal display as claimed in claim 1, wherein the reflective electrode is formed of a material comprising aluminum or silver.

6. A manufacturing method of a transflective liquid crystal display, comprising the following steps:
Step S1: providing a first backing and forming, in sequence, a thin-film transistor (TFT) array layer and a color resist layer on the first backing;
Step S2: forming a planarization layer on the color resist layer;
Step S3: coating a black-photo-spacer (BPS) material layer on the planarization layer and using a first mask to subject the BPS material layer to a photolithographic operation to form a BPS light-shielding layer,
wherein the BPS light-shielding layer comprises a black matrix and a main photo spacer and a sub photo spacer arranged on the black matrix and spaced from each other and the black matrix is provided, in a portion thereof other than portions in which the main photo spacer and the sub photo spacer are arranged, with a plurality of first bumps;
Step S4: forming a pixel electrode on the planarization layer and forming a reflective electrode on the black matrix to cover the plurality of first bumps, wherein the reflective layer forms a plurality of convex faces on an upper surface thereof to respectively correspond to the first bumps and the reflective electrode is connected to the pixel electrode to form a lower substrate; and
Step S5: providing an upper substrate, laminating the lower substrate and the upper substrate together, and positioning a liquid crystal layer between the upper substrate and the lower substrate,
wherein the liquid crystal layer has a portion corresponding to the reflective electrode and having a thickness that is one half of a thickness of a portion thereof corresponding to the pixel electrode.

7. The manufacturing method of the transflective liquid crystal display as claimed in claim 6, wherein the first mask comprises a multi-tone mask or a gray scale mask.

8. The manufacturing method of the transflective liquid crystal display as claimed in claim 6, wherein Step S2 comprises:
Step S21: coating an organic material layer on the color resist layer;
Step S22: using a second mask to subject the organic material layer to exposure and development so as to form a plurality of organic material patterns on the organic material layer, wherein each of the organic material patterns comprises a first organic block and a second organic block that are stacked together and the first organic block has a size greater than a size of the second organic block; and
Step S23: baking and shaping the plurality of organic patterns to form the planarization layer with a plurality of second bumps provided thereon,
wherein after the BPS light-shielding layer is formed on the planarization layer in Step S3, the black matrix is formed with the plurality of first bumps thereon to respectively correspond to the plurality of second bumps.

9. The manufacturing method of transflective liquid crystal display as claimed in claim 7, wherein Step S3 comprises:
Step S31: coating the BPS material layer on the planarization layer;
Step S32: using the first mask to subject to the BPS material layer to exposure and development to form the black matrix and the main photo spacer and the sub photo spacer that are located on the black matrix and also to form a plurality of black resist patterns in a portion of the black matrix other than the portions in which the main photo spacer and the sub photo spacer are arranged, wherein each of the black resist patterns comprises a first black resist block and a second black resist block that stacked together and the first black resist block has a size greater than a size of the second black resist block; and
Step S33: baking and shaping the plurality of black resist patterns to form the plurality of first bumps on the black matrix.

10. The manufacturing method of the transflective liquid crystal display as claimed in claim 6 further comprising:
Step S6: arranging an upper polarizer plate on one side of the upper substrate that is distant from the lower substrate, arranging a lower polarizer plate on one side of the lower substrate that is distant from the upper substrate, arranging quarter-wave plates at locations respectively between the upper substrate and the upper polarizer plate and between the low substrate and the lower polarizer plate, and arranging a backlight module at one side of the lower polarizer plate that is distant from the lower substrate so as to form the liquid crystal display;
wherein the upper substrate comprises a second backing and a common electrode arranged on the second backing, wherein Step S5 is conducted such that one side of the lower substrate that is provided with the pixel electrode is laminated onto one side of the upper substrate that is provided with the common electrode.

11. A transflective liquid crystal display, comprising: an upper substrate and a lower substrate that are arranged opposite to each other and a liquid crystal layer arranged between the upper substrate and the lower substrate;
wherein the lower substrate comprises a first backing, a thin-film transistor (TFT) array layer arranged on the first backing, a color resist layer arranged on the TFT array layer, a planarization layer covering the color resist layer, a black-photo-spacer (BPS) light-shielding layer arranged on the planarization layer, a pixel electrode arranged on the planarization layer, and a reflective electrode arranged on the BPS light-shielding layer;
the BPS light-shielding layer comprises a black matrix and a main photo spacer and a sub photo spacer arranged on the black matrix and spaced from each other, wherein the black matrix is provided, in a portion thereof other than portions in which the main photo spacer and the sub photo spacer are arranged, with a plurality of first bumps; the reflective electrode is arranged on the black matrix and covers the plurality of first bumps so as to form a plurality of convex faces on an upper surface thereof; and the reflective electrode is connected to the pixel electrode; and
the liquid crystal layer has a portion corresponding to the reflective electrode and having a thickness that is one half of a thickness of a portion thereof corresponding to the pixel electrode;
wherein the planarization layer is provided with a plurality of second bumps such that the black matrix is formed with the plurality of first bumps that respectively correspond to the plurality of second bumps;
further comprising an upper polarizer plate arranged on one side of the upper substrate that is distant from the lower substrate, a lower polarizer plate arranged on one side of the lower substrate that is distant from the upper substrate, and two quarter-wave plates respectively arranged between the upper substrate and the upper polarizer plate and between the low substrate and the lower polarizer plate;
wherein the upper polarizer plate has an optical axis that is parallel to an axis of the lower polarizer plate; and
wherein the transflective liquid crystal display further comprises a backlight module arranged on one side of the lower polarizer plate that is distant from the lower substrate;
wherein the upper substrate comprises a second backing and a common electrode arranged on one side of the second backing that is adjacent to the lower substrate; and
wherein the reflective electrode is formed of a material comprising aluminum or silver.
